(19) United States
(12) Patent Application Publication
(10) Pub. No.: US 2026/0280068 A1
(43) Pub. Date: Sep. 17, 2026

(54) BATTERY MODULE FIXING APPARATUS AND BATTERY MODULE FIXING METHOD USING THE SAME

(71) Applicant: LG ENERGY SOLUTION, LTD., Seoul (KR)

(72) Inventors: Sang Ok SEON, Daejeon (KR); Jee Won KIM, Daejeon (KR)

(21) Appl. No.: 19/469,254

(22) PCT Filed: Nov. 11, 2024
(86) PCT No.: PCT/KR2024/017756

§ 371 Date: Sep. 25, 2025

(30) Foreign Application Priority Data
Dec. 14, 2023 (KR) 10-2023-0182398

(51) Int. Cl. H01M 50/536; H01M 10/04; H01M 50/538; H01M 50/569

(52) U.S. Cl. CPC H01M 50/536; H01M 10/0481; H01M 50/538; H01M 50/569

(57) ABSTRACT

Disclosed are a battery module fixing apparatus including a holder unit including a first holder configured to allow a first surface of a first electrode lead to be in contact therewith and a second holder configured to allow a fourth surface of a second electrode lead to be in contact therewith, a pressing unit configured to move the second holder toward the first holder, a guide unit configured to guide linear movement of the holder unit, and a connection unit configured to allow the holder unit to be moved relative to or fixed to the guide unit therethrough and a battery module fixing method using the same.

### CROSS-REFERENCE TO RELATED APPLICATIONS

This application is a National Phase entry pursuant to 35 U.S.C. 371 of International Application PCT/KR2024/017756 filed Nov. 11, 2024, which claims the benefit of priority to Korean Patent Application No. 2023-0182398 filed on Dec. 14, 2023, the disclosure of which is incorporated herein by reference in its entirety.

### TECHNICAL FIELD

The present disclosure relates to a battery module fixing apparatus and a battery module fixing method using the same, and more particularly to a battery module fixing apparatus for assembling battery cells into a battery module without welding in order to electrically connect the battery cells to each other and a battery module fixing method using the same.

### BACKGROUND

With technological development of mobile devices and an increase in demand therefor, secondary batteries, which are capable of being charged and discharged, have been used as an energy source for various mobile devices. Secondary batteries have also attracted attention as an energy source for electric vehicles and hybrid electric vehicles presented as alternatives to existing gasoline and diesel vehicles, which use fossil fuels.

Required capacities of secondary batteries used as energy sources of various kinds of electronic devices inevitably used in modern society have been increased due to an increase in usage of mobile devices, increasing complexity of the mobile devices, and development of electric vehicles. In order to satisfy demand of users, a plurality of battery cells is disposed in a small-sized device, whereas a battery module including a plurality of battery cells electrically connected to each other or a battery pack including a plurality of battery modules is used in a vehicle, etc.

FIG. 1 is a view illustrating a conventional battery module provided with a busbar.

Referring to FIG. 1, leads 11 and 21 of a plurality of battery cells 10 and 20 are coupled to a busbar 30 by welding such that the battery cells are assembled into a battery module.

In the conventional battery module, the effect of fixation is increased as the leads 11 and 21 of the battery cells 10 and 20 are welded to the busbar 30, but there is the problem that the entirety of the battery module must be replaced when the battery cells 10 and 20 need to be replaced.

### Prior Art Document

(Patent Document 1) Korean Registered Patent Publication No. 10-2256733

### SUMMARY

The present disclosure has been made in view of the above problems, and it is an object of the present disclosure to provide a battery module apparatus capable of performing replacement on a battery cell basis and a battery module fixing method using the same.

As a technical means for achieving the above object, a battery module fixing apparatus according to an embodiment of the present disclosure includes a holder unit (100) including a first holder (110) configured to allow a first surface (11a) of a first electrode lead (11) to be in contact therewith and a second holder (120) configured to allow a fourth surface (21b) of a second electrode lead (21) to be in contact therewith, a pressing unit (200) configured to move the second holder (120) toward the first holder (110), a guide unit (300) configured to guide linear movement of the holder unit (100), and a connection unit (400) configured to allow the holder unit (100) to be moved relative to or fixed to the guide unit (300) therethrough.

Also, in the battery module fixing apparatus according to the embodiment of the present disclosure, the connection unit (400) may include a first connection member (410) at one surface of the first holder (110), the first connection member fixing the first holder (110) to the guide unit (300), and a second connection member (420) at an other surface of the second holder (120), the second connection member being configured to linearly move the second holder (120) relative to the guide unit (300).

Also, in the battery module fixing apparatus according to the embodiment of the present disclosure, the guide unit (300) may include a guide recess (310) corresponding to a linear movement section of the second connection member (420).

Also, in the battery module fixing apparatus according to the embodiment of the present disclosure, the second connection member (420) may include a projecting portion (421) inserted into the guide recess (310), the projecting portion being linearly movable relative to the guide recess (310), and the projecting portion (421) may be coupled to the guide recess (310) by male-female coupling so as to be linearly movable relative to the guide recess.

Also, in the battery module fixing apparatus according to the embodiment of the present disclosure, the pressing unit (200) may include a screw member (210) having a male thread on an outer surface thereof, the screw member being connected to the second holder (120), a ratchet gear (220) coupled to the screw member (210), the ratchet gear being on an outer surface thereof with a plurality of sawteeth (221), and a stopper member (230) caught between two adjacent ones (221) of the plurality of sawteeth (221) of the ratchet gear (220).

Also, in the battery module fixing apparatus according to the embodiment of the present disclosure, the ratchet gear (220) may be configured to allow rotation of the screw member (210) in a direction of rotation and to restrict rotation of the screw member in the opposite direction of rotation in the state in which the stopper member (230) is caught between two adjacent ones (221) of the plurality of sawteeth (221).

Also, in the battery module fixing apparatus according to the embodiment of the present disclosure, the screw member (210) may be configured to move the second holder (120) toward the first holder (110) upon rotating in the direction of rotation.

Also, in the battery module fixing apparatus according to the embodiment of the present disclosure, the first holder (110) may include a first protrusion (111) protruding toward the first surface of the first electrode lead (11), where the first protrusion (111) is on a surface of the first holder (110) in contact with the first surface (11a) of the first electrode lead (11).

Also, in the battery module fixing apparatus according to the embodiment of the present disclosure, the second holder (120) may include a second protrusion (121) protruding toward the fourth surface (21b) of the second electrode lead (21), where the second protrusion (121) is on a surface of the second holder (120) in contact with the fourth surface (21b) of the second electrode lead (21) with a second protrusion (121) protruding to one side.

Also, in the battery module fixing apparatus according to the embodiment of the present disclosure, each of the first holder (110) and the second holder (120) may be made of metal.

Also, the battery module fixing apparatus according to the embodiment of the present disclosure may further include a sensing unit (500) attached to the first holder (110), the sensing unit being indirectly connected to the first electrode lead (11) and the second electrode lead (21).

Also, in the battery module fixing apparatus according to the embodiment of the present invention, the holder unit (100) may comprise a plurality of holder units, the pressing unit (200) may comprise a plurality of pressing units, and the connection unit (400) may comprise a plurality of connections units.

In addition, a battery module fixing method using the battery module fixing apparatus according to the embodiment of the present invention includes (S1) inserting the first electrode lead (11) and the second electrode lead (21) into a gap between the first holder (110) and the second holder (120) and (S2) holding, by the holder unit (100), the first electrode lead (11) and the second electrode lead (21).

Also, in the battery module fixing method according to the embodiment of the present disclosure, in step (S2), the screw member (210) may be rotated in the direction of rotation such that the second holder (120) moves toward the first holder (110), and the holder unit (100) may hold the first electrode lead (11) and the second electrode lead (21).

As is apparent from the above description, in a battery module fixing apparatus according to the present disclosure and a battery module fixing method using the same, a holder unit holds a first electrode lead and a second electrode lead, whereby the first electrode lead and the second electrode lead may be connected to each other without a separate busbar structure, and welding is not required, which may be advantageous in a product process.

In addition, as described above, in the battery module fixing apparatus according to the present disclosure and the battery module fixing method using the same, a pressing unit may provide linear movement of a second holder, whereby only the battery cell that needs to be replaced may be replaced when battery cell replacement is required, and therefore it is possible to reduce the cost of replacing parts on a module basis.

### BRIEF DESCRIPTION OF THE DRAWINGS

FIG. 1 is a view illustrating a conventional battery module provided with a busbar.

FIG. 2 is a view showing the state in which a first electrode lead and a second electrode lead are disposed in a battery module fixing apparatus according to the present disclosure.

FIG. 3 is a perspective view illustrating a holder unit of the battery module fixing apparatus according to the present disclosure.

FIG. 4 is a view showing the state in which the holder unit of the battery module fixing apparatus shown in FIG. 2 holds the first f electrode lead and the second electrode lead.

FIG. 5 is a view illustrating coupling between a guide unit and a second connection member of the battery module fixing apparatus according to the present disclosure.

FIG. 6 is a view illustrating a pressing unit of the battery module fixing apparatus according to the present disclosure.

FIG. 7 is a view illustrating the state in which each of the holder unit, the pressing unit, and a connection unit is provided in plural in the battery module fixing apparatus according to the present disclosure.

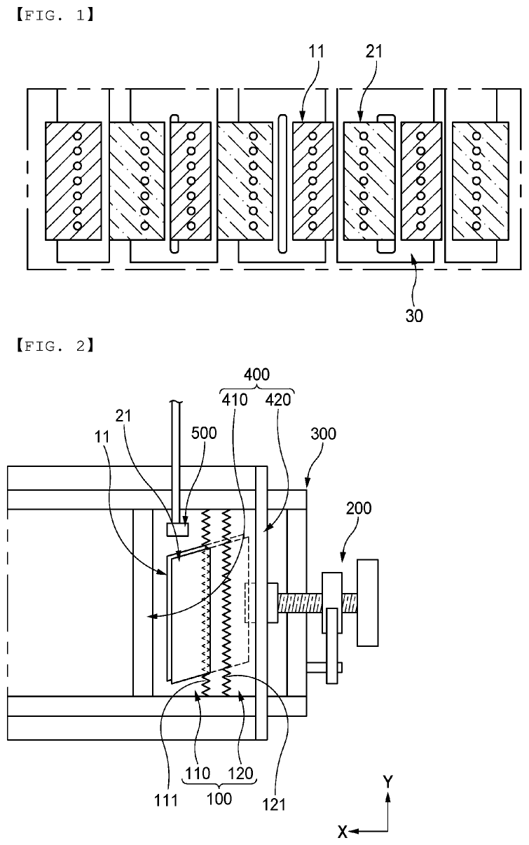

### DETAILED DESCRIPTION

Now, preferred embodiments of the present disclosure will be described in detail with reference to the accompanying drawings such that the preferred embodiments of the present disclosure can be easily implemented by a person having ordinary skill in the art to which the present disclosure pertains. In describing the principle of operation of the preferred embodiments of f the present disclosure in detail, however, a detailed description of known functions and configurations incorporated herein will be omitted when the same may obscure the subject matter of the present disclosure.

In addition, the same reference numbers will be used throughout the drawings to refer to parts that perform similar functions or operations. In the case in which one part is said to be connected to another part throughout the specification, not only may the one part be directly connected to the other part, but also, the one part may be indirectly connected to the other part via a further part. In addition, that a certain element is included does not mean that other elements are excluded, but means that such elements may be further included unless mentioned otherwise.

Hereinafter, a battery module fixing apparatus according to the present disclosure will be described.

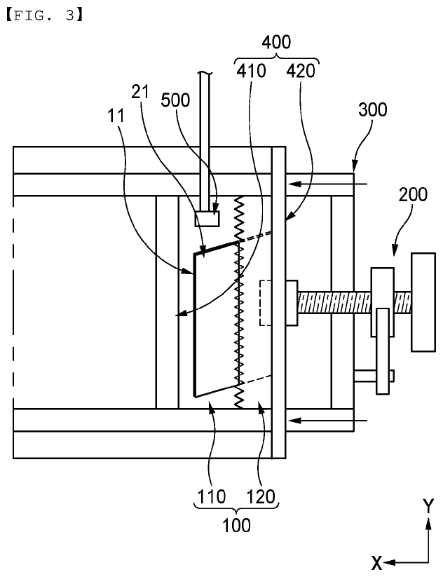

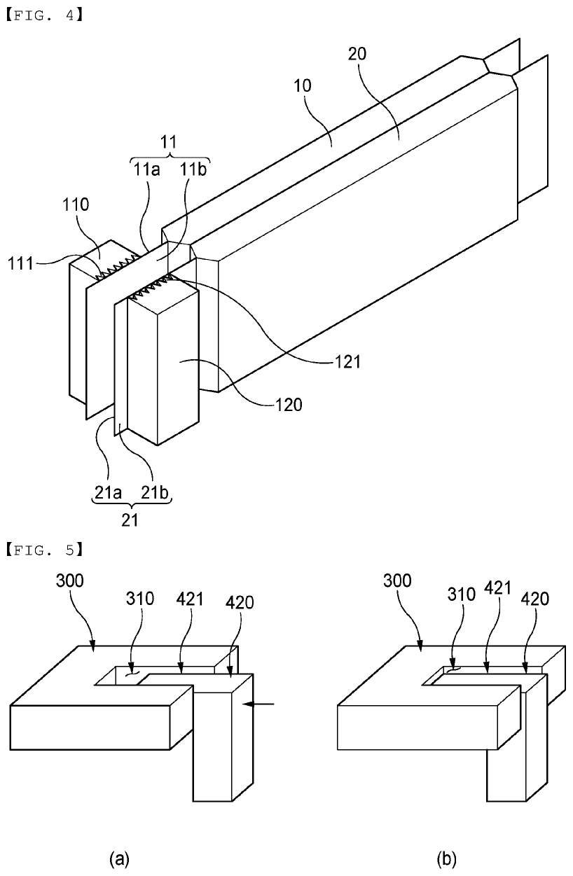

FIG. 2 is a view showing the state in which a first electrode lead and a second electrode lead are disposed in a battery module fixing apparatus according to the present disclosure, FIG. 3 is a perspective view illustrating a holder unit of the battery module fixing apparatus according to the present disclosure, and FIG. 4 is a view showing the state in which the holder unit of the battery module fixing apparatus shown in FIG. 2 holds the first electrode lead and the second electrode lead.

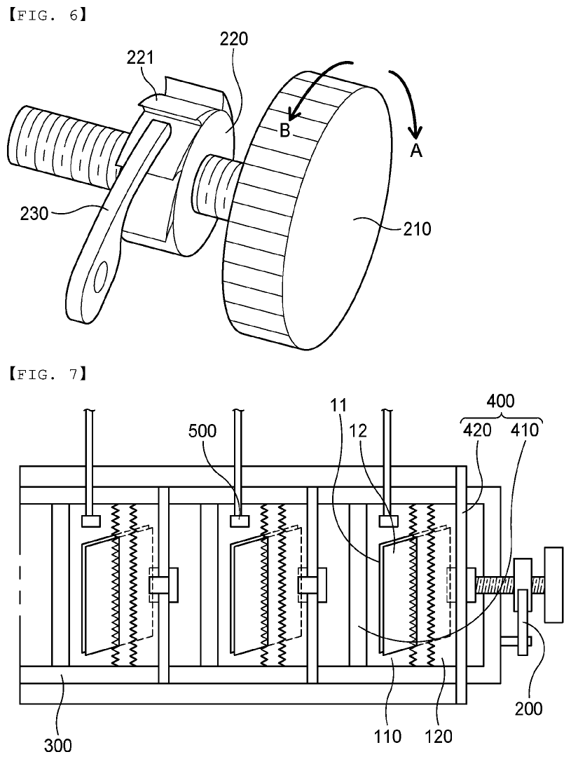

In addition, FIG. 5 is a view illustrating coupling between a guide unit and a second connection member of the battery module fixing apparatus according to the present disclosure, FIG. 6 is a view illustrating a pressing unit of the battery module fixing apparatus according to the present disclosure, and FIG. 7 is a view illustrating the state in which each of the holder unit, the pressing unit, and a connection unit is provided in plural in the battery module fixing apparatus according to the present disclosure.

Referring to FIGS. 2 to 7, the battery module fixing apparatus according to the present disclosure includes a holder unit 100, a pressing unit 200, a guide unit 300, a connection unit 400, and a sensing unit 500.

First, the holder unit 100 may include a first holder 110 and a second holder 120.

The first holder 110 may be configured to allow a first surface 11a of a first electrode lead 11 to be in contact therewith. For example, the first surface 11a of the first electrode lead 11 may be the surface located on one side (a 9 o'clock direction in FIG. 2).

In addition, the second holder 120 may be configured to allow a fourth surface 21b of a second electrode lead 21 to be in contact therewith. For example, the fourth surface 21b of the second electrode lead 21 may be the surface located on the other side (a 3 o'clock direction in FIG. 2).

In addition, for example, the first holder 110 and the second holder 120 may be spaced apart from each other, and the first electrode lead 11 and the second electrode lead 21 may be inserted (fitted) into a gap formed between the first holder 110 and the second holder 120.

The first holder 110 may be provided with a first protrusion 111, and the first protrusion 111 may protrude from the other surface of the first holder 110 in contact with the first surface 11a of the first electrode lead 11 to the other side.

In addition, the second holder 120 may be provided with a second protrusion 121, and the second protrusion 121 may protrude from one surface of the second holder 120 in contact with the fourth surface 21b of the second electrode lead 21 to one side.

For example, the first protrusion 111 of the first holder 110 and the second protrusion 121 of the second holder 120 may be configured to increase the pressing force when the first holder 110 and the second holder 120 hold the first electrode lead 11 and the second electrode lead 21, respectively.

In addition, each of the first holder 110 and the second holder 120 may be made of metal.

The first holder 110 and the second holder 120 may hold the first electrode lead 11 and the second electrode lead 21 inserted (fitted) therebetween in a state of being pressed by the pressing unit 200. At this time, a second surface 11b of the first electrode lead 11 and a third surface 21a of the second electrode lead 21 may be electrically connected to each other in contact with each other.

The pressing unit 200 may include a screw member 210, a ratchet gear 220, and a stopper member 230.

The screw member 210 has a male thread formed on an outer surface thereof, and may be connected to the second holder 120. For example, the screw member: 210 may be connected to the second holder 120 via a bolt and nut member provided at the second holder. As a result, the screw member 210 may move the second holder 120 toward the first holder 110 upon rotating in a direction of rotation A.

In addition, the ratchet gear 220 may be coupled to the screw member 210, and may be provided on an outer surface thereof with a plurality of sawteeth 221. For example, a hole may be formed in the center of the ratchet gear 220, and the screw member 210 may be coupled to the hole. The hole may be substantially aligned with the rotation axis of the ratchet gear 220.

The ratchet gear 220 may be configured to allow rotation of the screw member 210 in the direction of rotation A and to restrict rotation of the screw member in the opposite direction of rotation B in the state in which the stopper member 230 is caught between two adjacent ones 221 of the plurality of sawteeth 221.

For example, each of the plurality of sawteeth 221 of the ratchet gear 220 may be configured such that the angle of the surface thereof facing the direction of rotation A is less than the angle of the surface thereof facing the opposite direction of rotation B.

The stopper member 230 may be caught between two adjacent ones of the plurality of sawteeth 221 of the ratchet gear 220.

For example, the stopper member 230 may be configured in a form having a catching end that tapers toward the end thereof so as to be caught by the ratchet gear 220. For example, the end of the stopper member 230 may be pointed so as to be caught between two adjacent ones 221 of the plurality of sawteeth 221 of the ratchet gear 220.

In addition, for example, the end of the stopper member 230 may be located between the surface of one sawtooth 221 of the plurality of sawteeth 221 of the ratchet gear 220 facing the direction of rotation A and the surface of another sawtooth 221 adjacent thereto facing the opposite direction of rotation B to allow rotation of the ratchet gear 220 in the direction of rotation A and to restrict rotation of the ratchet gear in the opposite direction of rotation B.

A battery module may be fixed by the ratchet gear 220 and the stopper member 230. In addition, when it is necessary to replace parts on a battery cell basis, the stopper member 230 may be released from the ratchet gear 220, the screw member 210 may be rotated in the opposite direction of rotation B to release the fixation of battery cells, and only the battery cell that needs to be replaced may be replaced. As a result, the cost of replacing parts on a battery module basis may be reduced, and since busbar parts are not required, welding is not necessary, which may be advantageous in the product process.

The ratchet gear 220 and the stopper member 230 may be a ratchet gear and a stopper member known to those skilled in the art, respectively, and therefore a detailed description thereof will be omitted.

Meanwhile, the guide unit 300 may be configured to guide the linear movement of the holder unit 100. For example, the guide unit 300 may be provided above and under the first holder 110 and the second holder 120 to fix the first holder 110 and to guide the linear movement of the second holder 120. For example, Referring to FIGS. 2 and 3, the linear movement of the second holder 120 may be a movement in an X-axis direction.

A guide recess 310 may be formed in the guide unit 300, and a more detailed description of the guide recess 310 will be given later.

In addition, the connection unit 400 may include a first connection member 410 and a second connection member 420. The first connection member 410 is located at one surface of the first holder 110 (a 9 o'clock direction in FIG. 2) and may be configured to fix the first holder 110 to the guide unit 300.

The second connection member 420 is located at the other surface of the second holder 120 (a 3 o'clock direction in FIG. 2), and may be configured to linearly move the second holder 120 relative to the guide unit 300. For example, the second holder 120 may be connected to the second connection member 420 so as to be linearly moved together with the second connection member 420 when the second connection member is linearly moved.

That is, the connection unit 400 may be configured to allow the holder unit 100 to be moved relative to or fixed to the guide unit 300 therethrough.

A projecting portion 421 may be formed on the second connection member 420. The projecting portion 421 may be inserted into the guide recess 310 formed in the guide unit 300 and may be configured to be linearly movable relative to the guide recess 310.

The guide recess 310 may be a recess formed such that the second connection member 420 can be linearly moved relative to the guide unit 300. The guide recess 310 may be formed so as to correspond to a linear movement section of the second connection member 420.

The projecting portion 421 of the second connection member 420 may be coupled to the guide recess 310 by male-female coupling so as to be linearly movable relative to the guide recess. For example, the projecting portion 421 of the second connection member 420 may be inserted into the guide recess 310, and may be linearly movable along a recess length section of the guide recess 310 formed in a transverse direction.

In addition, the projecting portion 421 of the second connection member 420 may be linearly reciprocated along the recess length section of the guide recess 310.

In addition, the guide recess 310 formed in the guide unit 300 may be formed in an upper side and a lower side of the guide unit 300 that supports or fixes the first holder 110 and the second holder 120.

The sensing unit 500 may be attached to the first holder 110, and may be indirectly connected to the first electrode lead 11 and the second electrode lead 21.

For example, the sensing unit 500 may be a temperature sensor attached to the first holder 110 or the second holder 120 to indirectly measure the temperature of each of the first electrode lead 11 and the second electrode lead 21.

In another example, the sensing unit 500 may be a current sensor attached to the first holder 110 or the second holder 120 to detect the current of each of the first electrode lead 11 and the second electrode lead 21. The sensing unit 500 is not limited thereto, and any of various sensors known to those skilled in the art may be used.

In the battery module fixing apparatus according to the embodiment of the present disclosure, each of the holder unit 100, the pressing unit 200, and the connection unit 400 may be provided in plural, and the number of sensing units 500 may correspond to the number of holder units 100.

Hereinafter, a battery module fixing method using the battery module fixing apparatus according to the embodiment of the present disclosure will be described with reference to FIGS. 2 to 7.

The battery module fixing method according to the present disclosure includes (S1) a step of inserting a first electrode lead 11 and a second electrode lead 21 into the gap between the first holder 110 and the second holder 120 and (S2) a step of the holder unit 100 holding the first electrode lead 11 and the second electrode lead 21.

In step (S2), the screw member 210 may be rotated in the direction of rotation A such that the second holder 120 moves toward the first holder 110, and the holder unit 100 may hold the first electrode lead 11 and the second electrode lead 21.

After step (S2), when it is necessary to replace any one of fixed battery cells 10 and 20, the stopper member 230 may be separated from the ratchet gear 220, and the screw member 210 may be rotated in the opposite direction of rotation B to move the second holder 120 away from the first holder 110. Accordingly, the holder unit 100 may release the first electrode lead 11 and the second electrode lead 21, and any one of the battery cells that needs to be replaced may be replaced with a new battery cell.

Although the specific details of the present disclosure have been described in detail, those skilled in the art will appreciate that the detailed description thereof discloses only preferred embodiments of the present disclosure and thus does not limit the scope of the present disclosure. Accordingly, those skilled in the art will appreciate that various changes and modifications are possible, without departing from the category and the technical idea of the present disclosure, and it will be obvious that such changes and modifications fall within the scope of the appended claims.

What is claimed is:

1. A battery module fixing apparatus comprising:
a holder unit comprising a first holder configured to allow a first surface of a first electrode lead to be in contact therewith and a second holder configured to allow a fourth surface of a second electrode lead to be in contact therewith;
a pressing unit configured to move the second holder toward the first holder;
a guide unit configured to guide linear movement of the holder unit; and
a connection unit configured to allow the holder unit to be moved relative to or fixed to the guide unit therethrough.

2. The battery module fixing apparatus according to claim 1, wherein the connection unit comprises:
a first connection member at one surface of the first holder, the first connection member fixing the first holder to the guide unit; and
a second connection member at an other surface of the second holder, the second connection member being configured to linearly move the second holder relative to the guide unit.

3. The battery module fixing apparatus according to claim 2, wherein the guide unit includes a guide recess corresponding to a linear movement section of the second connection member.

4. The battery module fixing apparatus according to claim 3, wherein
the second connection member includes a projecting portion inserted into the guide recess, the projecting portion being linearly movable relative to the guide recess, and
the projecting portion is coupled to the guide recess by male-female coupling so as to be linearly movable relative to the guide recess.

5. The battery module fixing apparatus according to claim 1, wherein the pressing unit comprises:
a screw member having a male thread on an outer surface thereof, the screw member being connected to the second holder;
a ratchet gear coupled to the screw member, the ratchet gear being on an outer surface thereof with a plurality of sawteeth; and
a stopper member caught between two adjacent ones of the plurality of sawteeth of the ratchet gear.

6. The battery module fixing apparatus according to claim 5, wherein the ratchet gear is configured to allow rotation of the screw member in a direction of rotation and to restrict rotation of the screw member in an opposite direction of rotation in a state in which the stopper member is caught between two adjacent ones of the plurality of sawteeth.

7. The battery module fixing apparatus according to claim 6, wherein the screw member is configured to move the second holder toward the first holder upon rotating in the direction of rotation.

8. The battery module fixing apparatus according to claim 1, wherein the first holder includes a first protrusion protruding toward the first surface of the first electrode lead, wherein the first protrusion is on a surface of the first holder in contact with the first surface of the first electrode lead.

9. The battery module fixing apparatus according to claim 1, wherein the second holder includes a second protrusion protruding toward the fourth surface of the second electrode lead, wherein the second protrusion is on a surface of the second holder in contact with the fourth surface of the second electrode lead.

10. The battery module fixing apparatus according to claim 1, wherein each of the first holder and the second holder is made of metal.

11. The battery module fixing apparatus according to claim 10, further comprising a sensing unit attached to the first holder, the sensing unit being indirectly connected to the first electrode lead and the second electrode lead.

12. The battery module fixing apparatus according to claim 1, wherein of the holder unit comprises a plurality of holder units, the pressing unit comprises a plurality of pressing units, and the connection unit comprises a plurality of connection units.

13. A battery module fixing method using the battery module fixing apparatus according to claim 1, the battery module fixing method comprising:
(S1) inserting the first electrode lead and the second electrode lead into a gap between the first holder and the second holder; and
(S2) holding, by the holder unit, the first electrode lead and the second electrode lead.

14. The battery module fixing method according to claim 13, wherein, in step (S2), a screw member is rotated in a direction of rotation such that the second holder moves toward the first holder, and the holder unit holds the first electrode lead and the second electrode lead.
